(19) United States
(12) Patent Application Publication
(10) Pub. No.: US 2011/0108180 A1
(43) Pub. Date: May 12, 2011

(54) METHOD FOR PRODUCING A CURVED CIRCUIT

(75) Inventors: Manuel Fendler, Grenoble (FR); Delphine Dumas, Grenoble (FR)

(73) Assignee: Commissariat A L'Energie Atomique Et Aux Energies Alternatives, Paris (FR)

(21) Appl. No.: 12/869,433

(22) Filed: Aug. 26, 2010

(30) Foreign Application Priority Data
Nov. 6, 2009 (FR) 0957883

(51) Int. Cl. H01B 13/00

(52) U.S. Cl. 156/50

(57) ABSTRACT

The invention relates to a method for producing a curved circuit. According to the invention, this method involves forming, in one face of said circuit and in at least one predetermined direction, cuts having a triangular cross-section which are parallel to each other and extend to either side of said circuit; depositing adhesive on the flanks of the cuts thus made; and moving the flanks of the cuts together so as to close them.

### CROSS REFERENCE TO RELATED APPLICATIONS

This application claims priority under 35 U.S.C. §119 from French Patent Application No. 0957883 filed on Nov. 6, 2009 in the French Patent Office, the entire disclosure of which is incorporated herein by reference.

### FIELD OF THE INVENTION

The invention relates to curved electronic circuits and, more especially, electromagnetic radiation detectors, regardless of their spectral region.

### DESCRIPTION OF THE PRIOR ART

In both photography and video, digital images are currently formed on planar sensors for essentially historical reasons associated with the flat shape of analogue films and manufacturers' existing installed optical equipment. Most research has therefore concentrated on improving resolution in terms of the number of unitary detection units or pixels and on managing the digital noise caused by high signal amplification gains.

Nevertheless, the use of planar sensors directly results in a certain number of both geometrical and chromatic aberrations which include barrel distortion and pincushion distortion, spherical aberrations (or “diffuse light” aberrations), coma, astigmatism, vignetting, blooming, spurious light (reflection) and even chromatic aberrations. Such aberrations have to be corrected at the time when images are actually formed by using complex optics and/or subsequently by implementing image processing algorithms which demand considerable computing power. Thus, the planar nature of sensors is the direct cause of aberrations and correcting these requires bulky, expensive lenses and powerful on-board computers in cameras and digital cameras.

However, such aberrations disappear if the sensor has a spherical shape similar to that of an animal's eye. The ability to curve the sensor therefore makes it possible not only to correct aberrations but also to devise affordable and compact cameras that do not require significant computing power and offer enhanced visual acuity which can be as high as 180° in the case of fisheye type lenses.

The attractiveness of designing curved sensors in the field of imaging is therefore readily apparent.

Curved sensors also have advantages in other fields such as optical spectrometry. It is known that optical spectrometers form a diffraction pattern on a spherical surface. Adjusting an optical spectrometer essentially involves optimising the position of the planar sensor relative to the spherical surface on which the diffraction pattern is formed and managing the offset between them. The document entitled “Concept of a miniature optical spectrometer using integrated optical and micro-optical components” by Ivan Avratusky et al., Applied Optics, vol. 45, No. 30, October 2006 elucidates the problems caused by a planar sensor in the field of optical spectrometry. Realising a curved sensor would thus make it possible to position detection ideally on this spherical surface.

Usually, digital sensors, regardless of their technology (CCD or CMOS in the visible region, CdHgTe-based in the infrared region, etc.) and configuration (monolithic, hybrid, etc.) comprise a substrate in which a pixel readout circuit is formed, with the substrate having a thickness of several tens of micrometres up to several millimetres.

Producing a curved substrate, or more generally producing a flexible circuit, remains difficult for such thicknesses.

In fact, curving a flat circuit which is significantly thick (typically in excess of 50 um) and therefore significantly rigid causes defects which adversely affect the quality of the circuit such as, for example, beading, cracking, tearing and even destruction of the connections and electrical components which the circuit contains.

To avoid such drawbacks, it is possible to design a circuit which is relatively thin (typically less than 50 μm) and is consequently very flexible and then bond it onto a support which has the desired curvature.

However, a very thin circuit is awkward to manipulate without using expensive gripping devices. Not only that, the slightest defect (dust, blister, inhomogeneity in bonding resin, etc.) on a surface which comes into contact with the circuit, regardless whether it is a surface defect of the gripping devices or the support which accommodates the circuit, has an impact on the circuit and impairs the quality of the circuit, thus adversely affecting its operation and even destroying the connections or electrical components which the circuit contains. Manipulating a very thin circuit therefore necessitates particularly expensive protective measures.

### SUMMARY OF THE INVENTION

The present invention aims to solve the above-mentioned problems by proposing a method that makes it possible to curve a circuit which is initially flat and is significantly thick and makes it possible to maintain adequate mechanical rigidity to allow easy manipulation.

For this purpose, the object of the invention is a method for fabricating a curved circuit involving forming on one face of said circuit and in at least one predetermined direction triangular parallel cuts which extend as far as either side of said circuit; depositing an adhesive on the flanks of the cuts thus made; and moving the flanks of the cuts together so as to close them.

Circuits having a thickness of less than a millimetre, e.g. a thickness of 50 μm to 1 mm, are referred to here.

Note that the role of the substrate, the usual component of a circuit on which all the electronic components are fabricated using thin film technology (the layer deposited on the substrate and comprising these components is commonly referred to as the “active layer”), is solely intended to ensure the mechanical strength of the circuit, thus making it possible to manipulate the circuit at each stage of its manufacturing process. Eliminating the substrate and only retaining a small thickness underneath the active layer makes manipulating the circuit, during fabrication, very difficult and requires tools that are expensive and awkward to use. The problems involved in gripping extremely thin devices (<50 μm) are dealt with in the document entitled “3D and TSV Report: Cost, Technologies and Market”, published by Yole Développement and updated in November 2007, pp. 186-203.

In other words, the bottoms of the cuts define lines of deliberate weakness which make it possible to fold the circuit in the location of these cuts, thus curving the circuit. In addition, having removed material, when the circuit is curved by moving the flanks of the cuts closer together, there is no beading or tearing. The circuit can thus be made significantly thick to make it mechanically strong. Finally, providing cuts having a triangular cross-section makes it possible to close up the latter, thus obtaining an annular portion in a plane which is perpendicular to the cuts.

According to one advantageous aspect of the method of the invention, the width of the cuts is chosen to satisfy the following equation:

$${L}_{lower} er = {L}_{upper} \times ( 1 - \frac{W}{{R}_{c}} )$$

where:

L_{lower} is the length of an arc of circle formed by the face of the circuit in which the cuts are formed once the cuts have been closed up,

Lᵤₚₚₑᵣ is the length of an arc of circle formed by the face of the circuit that is opposite the face in which the cuts are formed once the cuts have been closed up,

W is the thickness of the circuit, and

R_{c} is the desired radius of curvature of the circuit.

In addition, the residual thickness of the circuit above the bottom of the cuts is advantageously less than 50 μm and the width of said cuts is equal to or greater than 100 μm.

According to the invention, the total widths of the cuts is advantageously less than 75% of the width of the face in which they are formed so as not to make the device fragile with too little substrate to ensure mechanical strength.

Finally, the cuts can be formed in different directions in order to obtain anisotropic curvature of the circuit.

### BRIEF DESCRIPTION OF THE DRAWINGS

The invention will be made more readily understandable by reading the following description which is given merely by way of example and relates to the accompanying drawings in which identical references denote identical or functionally analogous components and in which:

FIGS. 1 to 5 are schematic cross-sectional views of a monolithic circuit at various stages of the method according to the invention;

FIG. 6 is a schematic cross-sectional view of a hybrid circuit according to the prior art which is especially suitable for curving using the method according to the invention;

FIG. 7 is a schematic top view of a circuit which shows the orientation of the cuts in various directions.

### DETAILED DESCRIPTION OF THE INVENTION

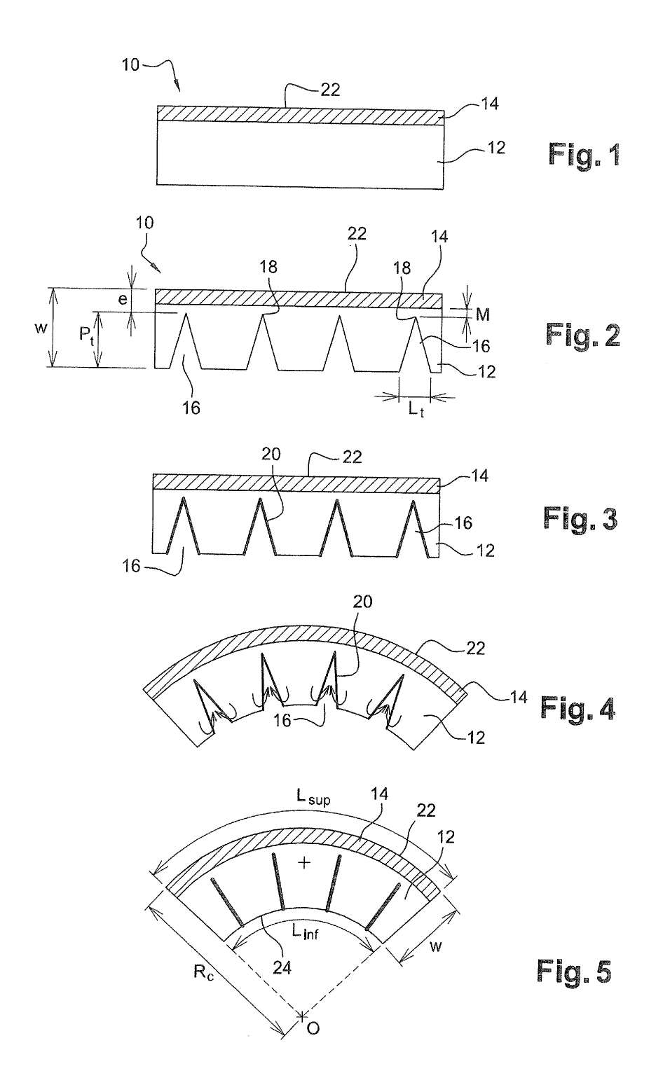

In FIG. 1, a planar monolithic electronic circuit 10, for example an image sensor produced using CCD or CMOS technology, comprises a silicon substrate 12 which forms the support on which so-called active layer 14 is formed. This layer comprises all the electronic elements that are needed in order to form and read images as is known in itself from the prior art. Planar circuit 10 is realised using conventional techniques which, for the sake of brevity, are not described in greater detail here.

According to the invention, cuts 16 which have a triangular cross-section are then formed in the exposed face of substrate 12 (FIG. 2) and extend right through the latter. More precisely, the cuts extend through circuit 10. Cuts 16 are made using conventional techniques, for example cutting, dry or wet etching, micro milling etc.

The shape and dimensions of the cuts are chosen so as to obtain the desired curvature of circuit 10, this curvature not necessarily being an arc of a circle, and so as to define “score” lines along which circuit 10 will subsequently fold in a predictable way in order to obtain the desired curvature.

More especially, if the cross-section of cuts 16 is an isosceles triangle, the width Lₜ of cuts 16, the number of cuts 16 and their spacing are chosen so as to obtain the desired curvature in an arc of a circle of circuit 10. The depth Pₜ of cuts 16 is chosen to adjust the residual thickness e of circuit 10 at the bottom 18 of cuts 16 in a manner which is explained in greater detail below.

The method according to the invention then involves depositing adhesive 20, for example epoxy adhesive, on the flanks of cuts 16 (FIG. 3). The adhesive is deposited, for instance, by using a syringe which dispenses the adhesive into the mouth of cuts 16 with the adhesive then migrating into said cuts and consequently onto their flanks due to capillary action.

Once adhesive 20 has been deposited on the flank of cuts 16, circuit 10 is bent in order to close the cuts (FIG. 4). For example, circuit 10 is mounted on an elastic membrane or on a shape-memory material which is kept flat and then, when it is released, assumes the desired shape for circuit 10.

Such a spherical shaped membrane is, for instance, described in the document entitled “A hemispherical electronic eye camera based on compressible silicon optoelectronics” by H. Cho KO et al, Nature, vol. 454, pp 748-753, August 2008. It should be noted that this document discloses an array of pixels which are connected by flexible connections and that the curvature of the substrate and the readout circuit which are necessarily associated with said pixels is not described and the thickness thereof is such that they cannot be directly curved by using the membrane as described above.

By assuming its original shape, the membrane causes cuts 16 to close up and therefore produces the desired curvature of circuit 10, namely, in the example shown, an annular portion of a sphere having a radius R_{c} in a plane which is perpendicular to the direction in which the cuts are formed (FIG. 5).

In order to obtain curvature in an arc of a circle having a radius R_{c} of exposed surface 22 of active layer 14 which can be, for instance, the detection surface of an image sensor, the shape and dimensions of the cuts are chosen so as to satisfy the following equation:

$${L}_{lower} = {L}_{upper} \times ( 1 - \frac{W}{{R}_{c}} )$$

where:

L_{lower} is the length of the exposed surface 24 of circuit 10 which faces towards the centre of curvature O of circuit 10 once it is curved, i.e. the exposed surface of substrate 12 once circuit 10 is curved (FIG. 5),

Lᵤₚₚₑᵣ is the length of exposed surface 24 opposite surface 22, i.e. the surface of layer 14, and

W is the thickness of circuit 10.

In the case where circuit 10 initially assumes the shape of a rectangular parallelogram and choosing identical cuts having an isosceles cross-section and constant spacing, as is the case in the example shown, width Lₜ then equals:

$${L}_{t} = \frac{{L}_{upper} - {L}_{lower}}{N}$$

where N is the number of cuts.

The depth Pₜ of cuts 16 is chosen so that the residual height e=W−Pₜ is less than 50 μm and greater than 15 μm. This way, sufficient flexibility of circuit 10 at the bottoms 18 of the cuts is obtained thanks to its thinness, without creating any risk of tearing the circuit.

Also, because active layer 14 comprises electronic components and connections, it is preferable to leave a margin M between the bottom 18 of cuts 16 of around 10 μm so as to avoid the risk of damaging said electronic components and connections when cuts 16 are made.

As an example of the numbers involved, for circuit 10 having a thickness W of 525 micrometres and a width Lᵤₚₚₑᵣ of 10 millimetres and a 25 μm active layer 14 which is to be given a 17.2 mm radius of curvature, there must be a total of 300 μm of cuts 16, i.e., for instance, three 100 μm cuts each separated by a distance of 2425 μm.

The width of the cuts is preferably equal to or greater than 100 μm in order to be able to use syringes according to the prior art to dispense adhesive 20 into the cuts.

The total widths of the cuts is preferably less than 75% of the width of the face in which they are formed in order not to make the device fragile with too little substrate to ensure mechanical strength.

An embodiment whereby curvature in an arc of a circle is obtained by means of evenly distributed identical cuts having an isosceles cross-section is described above.

Obviously, different curvatures can be obtained depending on the sought-after applications and/or construction and assembly constraints. For example, the cuts can have different widths and/or be unevenly spaced.

Similarly, an embodiment in which a monolithic circuit, for example a CCD or CMOS sensor in which the detection elements are integrated in the active layer, especially for the sake of wiring simplicity, is described above.

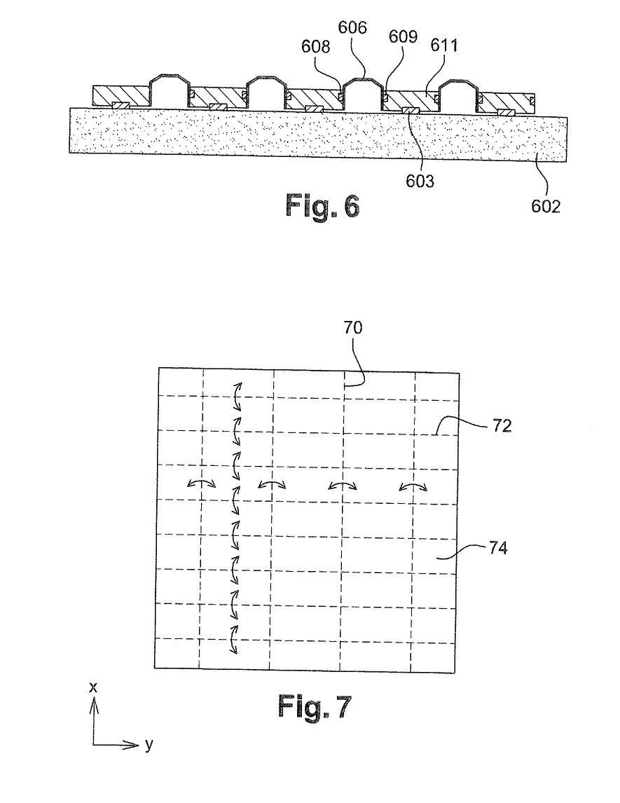

The present invention is nevertheless also applicable to a hybrid circuit, advantageously that described in Application WO2008/007008, FIG. 6d of which is reproduced here as FIG. 6.

According to this document, electronic device 620 comprises a plurality of electronic components 611 mounted on substrate 602. Each component 611 is mechanically connected to substrate 602 via a connecting element 603 such as a solder bump for example. Every component 611 is also electrically connected to a least one adjacent component by means of at least one conductor 606. Conductors 606 are sufficiently elastic to preserve the integrity of the electrical connection with an adjacent component despite relative movement between said components.

Having realised such a device 620, it is then possible to curve it by using the method according to the present invention on substrate 602, conductors 606 being sufficiently elastic to stretch without breaking.

Alternatively, substrate 602 is initially curved in accordance with the invention and then elements 611 and their conductor 606 are subsequently mounted on the curved substrate.

Similarly, curvature in a single direction is described above. Obviously, the invention can also be used to curve a circuit in two dimensions.

For example, as shown in FIG. 7, a first set of cuts 70 can be made in first direction x and a second set of cuts 72 can be made in second direction y, at right angles to first direction x.

By choosing identical cuts and the same spacing for the two sets of cuts 70, 72, it is possible to obtain a circuit which assumes the shape of a portion of a sphere.

Anisotropic curvature can also be obtained by choosing different sets of cuts, for instance different cuts and/or different spacings, in which case the curvature in the first direction will be different to the curvature in the second direction, as is the case in FIG. 7.

Similarly, it is possible to choose cuts that form not a rectangular grid 74 as shown in FIG. 7, but a pentagonal, hexagonal, etc. grid.

The invention achieves a curved circuit of considerable thickness which means, in particular, that it can be manipulated easily without risk of damaging it if it comes into contact with irregular surfaces; curvature which can be isotropic or anisotropic depending on the sought-after applications; and a method which does not make it necessary to revise the design of the planar circuit that is to be curved. In fact, the circuit can be fabricated using conventional techniques and then be curved. In particular, there is no need to provide differentiated treatment for the layer which comprises the electronic elements and connections of the circuit.

We claim:

1. A method for producing a curved circuit, wherein it involves:
forming, in one face of said circuit and in at least one predetermined direction, cuts having a triangular cross-section which are parallel to each other and extend to either side of said circuit;
depositing an adhesive on the flanks of the cuts thus made; and
moving the flanks of the cuts together so as to close them.

2. The method for producing a curved circuit as claimed in claim 1, wherein the width of the cuts is chosen so as to satisfy the equation:
$${L}_{lower} = {L}_{upper} \times ( 1 - \frac{W}{{R}_{c}} )$$
where L_{lower} is the length of an arc of circle formed by the face of circuit in which cuts are formed once they have been closed, Lᵤₚₚₑᵣ is the length of an arc of circle formed by a face of the circuit opposite to the face in which the cuts are formed when the cuts have been closed, W is the thickness of the circuit and R_{c} is the desired radius of curvature of the circuit.

3. The method for producing a curved circuit as claimed in claim 1, wherein the residual thickness (e) of the circuit above the bottom of cuts is less than 50 μm.

4. The method for producing a curved circuit as claimed in claim 1, wherein the width (Lₜ) of cuts is equal to or greater than 100 μm.

5. The method for producing a curved circuit as claimed in claim 1, wherein the total widths (Lₜ) of cuts is less than 75% of the width of the face in which the cuts are formed.

6. The method for producing a curved circuit according to claim 1, wherein it involves forming cuts in different directions in order to obtain anisotropic curvature of the circuit.
